(19) United States
(12) Patent Application Publication
(10) Pub. No.: US 2009/0191374 A1
(43) Pub. Date: Jul. 30, 2009

(54) DEVICE HAVING MULTI-PHASE SURFACES FOR SMUDGE PREVENTION

(75) Inventors: John D'Urso, Chandler, AZ (US); Yi Wei, Chandler, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 12/019,168

(22) Filed: Jan. 24, 2008

(51) Int. Cl. B32B 3/26; B32B 1/04

(52) U.S. Cl. 428/76; 428/304.4; 428/319.3

(57) ABSTRACT

A device (200, 300) makes smudges (406), including oils and dust, unnoticeable when formed on a viewable surface (201) thereof. The device (200, 300) includes a transparent layer (202) overlying a housing (102, 104) and/or a display (110, 150). A multi-phase structure (204, 206) is disposed on the transparent layer (202), the multi-phase structure (204, 206) comprising a solid porous matrix (204) defining a plurality of pores (208), and a non-solid material (206), for example, a liquid or a gel, disposed within the pores (208).

### FIELD

The present invention generally relates to electronic devices and more particularly to an apparatus making smudges, including oils and dust, unnoticeable when formed on a viewable surface of, for example, a housing or a display.

### BACKGROUND

The use of portable electronic devices such as cell phones, personal data assistants, and digital media players has become very widespread resulting in two trends. The first trend is the use of larger displays and the increase in the use of glass or a thermoplastic as a transparent display cover. While these layers have excellent transparency and are physically strong, they suffer both aesthetic and functional degradation due to the build up of oils and other contaminants during use. The other trend is the use of very high gloss materials for the housing with a focus on the aesthetic appeal of the device, which suffers a similar aesthetic and functional degradation due to the build up of oils and other contaminants during use. This is particularly true for products which receive significant handling, such as persona data assistants (PDAs) and cell phones. This has led to the result that any type of fouling (smudging) is especially undesirable as it tends to be very noticeable and can degrade both the functional and aesthetic performance of the device.

While smudges can come from a variety of sources, fingerprints are common to virtually all users. The main approach taken to preventing fingerprints has been to coat the surfaces with hydrophobic, low surface energy films such as silicones or fluorocarbons. The hydrophobicity has been further enhanced through the use of numerous methods which have the effect of creating surface texture. These methods include the application of emulsion, layer by layer, and lithographic patterning techniques. While these approaches may increase water or oil contact angles, they have not been effective in preventing the transfer of fingerprints, but only in making the surfaces easier to clean at best. These techniques further suffer from the fact that they may affect transparency or be unnecessarily complex and expensive. For example, see “Fabrication of Super Water-Repellent Surfaces by Nanosphere Lithography”, Jau-Ye Shiu et al., Mat. Res. Soc. Symp. Proc., Vol. 823, pages W11.4.1-6, 2004

Accordingly, it is desirable to provide a surface of an electronic device display or housing that is resistant to smudges. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a front view of a mobile communication device having a display, a touch screen, and a housing that may include a surface in accordance with an exemplary embodiment;

FIG. 2 is a partial cross-section of the surface of the display, the touch screen, or the housing in accordance with an exemplary embodiment;

FIG. 3 is a picture of a porous alumina structure taken from the top at an angle forming the surface of an electronic device in accordance with an exemplary embodiment;

FIG. 4 is a side by side top view of a comparison of a porous alumina/glycerol multi-phase structure in accordance with the exemplary embodiment and glass immediately after application of a smudge; and

FIG. 5 is a side by side top view of a comparison of a porous alumina/glycerol multi-phase structure in accordance with the exemplary embodiment and glass delayed in time after application of a smudge.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

A surface being exposed to smudges, instead of a homogeneous solid, comprises multiple regions of different phases. A porous structure presenting minimal surface has a liquid disposed therein. There are a number of ways structures which facilitate this situation can be fabricated. This can be accomplished by a variety of methods, including polymer casting/spraying. One exemplary embodiment providing transparency includes depositing and anodizing an aluminum film, creating a porous anodic alumina layer. The resulting porous structures can then be filled with a non-solid material such as a liquid or gel, or other material that can transform to a liquid state or otherwise act like a liquid when touched. Mass transfer (smudge creation) occurs in the presence of a liquid rather than solely a vapor and may be retarded in a number of ways.

Fingerprint transfer can be thought of as a transfer of a liquid, usually an oil, from a finger to a surface, thereby wetting the surface. The Young-Dupre equation demonstrates a balance of the interfacial energies for the oil on a solid surface surrounded by an ambient, i.e. gamma[oil, surface]+gamma[oil, ambient] cos(theta)=gamma[ambient, surface]. Conditions for absolute wetting or non-wetting may be derived. This can be done from the viewpoint of the oil being de-wetting or the ambient being completely wetting. Either way, the condition to have the ambient completely wetting or the oil completely non-wetting is gamma [surface, oil]>gamma[surface, ambient]+gamma[ambient, oil]. If this condition is fulfilled, then a drop of oil would not be able to wet the substrate. This condition does not necessarily need to be fulfilled in reality to retard transfer because the oil is not being dropped onto the surface but is being transferred by a finger. The interfacial energies only need to be changed to make retention of the oil to the finger more energetically favorable.

It is recognized that other phenomena take place as well which may retard or otherwise affect transfer. For instance, in a porous structure filled with an incompressible material, it is more difficult to get a contaminated finger in contact with the solid surface. This would retard mass transfer taking place a as contaminant liquid to solid surface transfer as well as a solid contaminant to solid surface transfer. Furthermore, it interrupts the condensation of liquid or solid contaminants soluble in the liquids from the finger onto the solid surface.

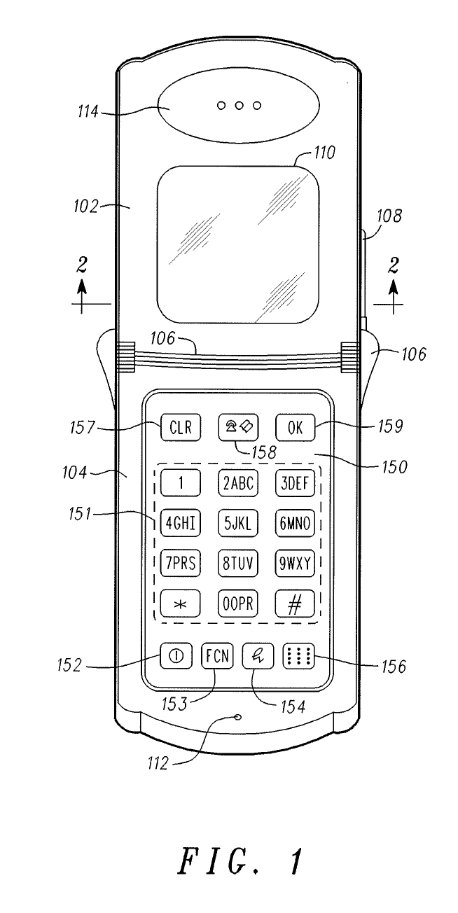

Although the apparatus described herein may be used with an exposed surface for any type of device, the exemplary embodiment as shown in FIG. 1 comprises a mobile communication device 100 implementing a display or touch screen. While the device shown is a mobile communication device 100, such as a flip-style cellular telephone, the exemplary embodiments can also be implemented in cellular telephones with other housing styles, personal digital assistants, television remote controls, video cassette players, household appliances, automobile dashboards, billboards, point-of-sale displays, landline telephones, and other devices susceptible to smudges.

The mobile communication device 100 has a first housing 102 and a second housing 104 movably connected by a hinge 106. The first housing 102 and the second housing 104 pivot between an open position and a closed position. An antenna 108 transmits and receives radio frequency (RF) signals for communicating with a complementary communication device such as a cellular base station. A display 110 positioned on the first housing 102 can be used for functions such as displaying names, telephone numbers, transmitted and received information, user interface commands, scrolled menus, and other information. A microphone 112 receives sound for transmission, and an audio speaker 114 transmits audio signals to a user.

A keyless input device 150 is carried by the second housing 104. The keyless input device 150 is implemented as a touchscreen with a display. A main image 151 represents a standard, twelve-key telephone keypad. Along the bottom of the keyless input device 150, images 152, 153, 154, 156 represent an on/off button, a function button, a handwriting recognition mode button, and a telephone mode button. Along the top of the keyless input device 150, images 157, 158, 159 represent a “clear” button, a phonebook mode button, and an “OK” button. Additional or different images, buttons or icons representing modes, and command buttons can be implemented using the keyless input device. Each image 151, 152, 153, 154, 156, 157, 158, 159 is pixel driven, and this keyless input device uses a display with aligned optical shutter and backlight cells to selectively reveal one or more images and provide contrast for the revealed images in both low-light and bright-light conditions.

Those skilled in the art will appreciate that many types of displays may be utilized with the exemplary embodiments, including, for example, transmissive, reflective or transflective liquid crystal displays, cathode ray tubes, micromirror arrays, and printed panels. The transparent cover preferably is resistant to scratching and cracking due to extreme environmental conditions and use.

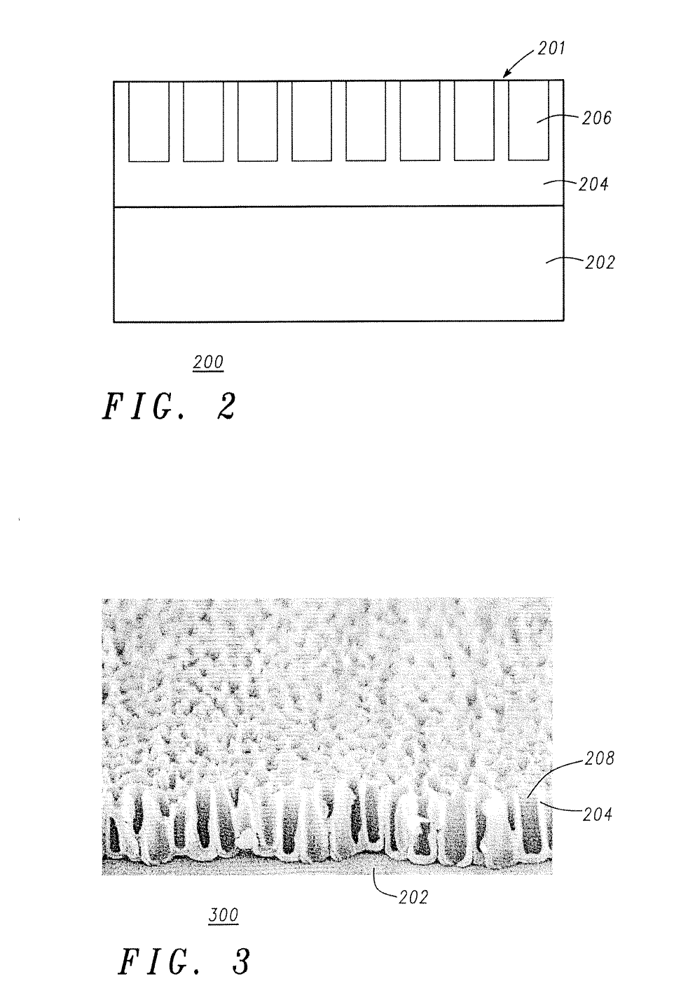

Referring to FIG. 2, a cross section of a surface of a structure 200 as disposed, for example, on the housings 102, 104, the display 110, and the keyless input device 150, in accordance with an exemplary embodiment is depicted. The structure 200 is a stack with a user-viewable and user-accessible face 201 and multiple layers below the face 201, including a layer 202, a solid porous matrix 204, and a liquid 206 disposed in pores 208 within the solid porous matrix 204. When the structure 200 overlies the display 110 or the keyless input device 150, the layer 202 (which may be part of the underlying display 110 or keyless input device 150) is a transparent material 202, for example plastic such as polycarbonate or polyethylene terephthalate, or glass, providing protection to the underlying display 110 and keyless input device 150 while providing support for the solid porous matrix 204. When the structure 200 overlies the housing 102, 104, the layer 202 may be omitted, with the solid porous matrix 204 disposed directly on the housing 102, 104.

The solid porous matrix 204 in the exemplary embodiment is formed by forming a film of aluminum of about 500 nanometers thick onto the layer 202. This formation is preferably accomplished by sputtering, but other methods such as evaporation may be used. The layer 202 containing the aluminum film is immersed in an acid of, for example, sulphuric acid (H₂SO₂) or phosphoric acid (H₂PO₄) at 25° C. or less. A voltage is applied between the aluminum film and the acid, changing the aluminum to aluminum oxide (Al₂O₃) comprising the solid porous matrix 204. As the aluminum film is anodized, the current drops as it is oxidized. Layer 202 may also comprise an aluminum/metal stack to facilitate complete and even anodization where the metal is, for example, titanium, niobium, tungsten, or tantalum. The picture of FIG. 3 shows the solid porous matrix 204 created by anodizing a film formed via the sputtering method. The pores 208 comprise a void or voids within the oxidized aluminum.

The pores 208 may optionally be widened by placing the structure 300, for example, in a 5% phosphoric acid (H₂PO₄) for 20 minutes at 30° C. without a voltage being applied. The pore widening process reduces the sidewall thickness and eliminates the residual metallic aluminum, thus reducing the solid surface area as well as improves the transparency of the film.

The liquid 206 (or non-solid material, which may include a gel) may be applied to the solid porous matrix 204 by any one of several methods, including wet impregnation, spin coating, spray coating, condensation, wiping, or a modified Langmuir-Blodgett approach. The liquid 206 preferably has a high surface tension, low viscosity, and low vapor pressure. The following chart illustrates these characteristics for the examples including water, glycerol, and ethylene glycol.

| | SURFACE | VISCOSITY | VAPOR |
|---|---|---|---|
| | TENSION | @ 20 or 25 c. | PRESSURE |
| LIQUID | (Mn/m) | (mPa s) | (mmHg) |
| Water | 73 | 1 | 17.54 at 20° C. |
| Glycerol | 64 | 1420 | 0.0025 at 50° C. |
| Ethylene | 48 | 16 | 0.06 at 20° C. |
| Glycol | | | |

While water has a low viscosity and a high surface tension, its vapor pressure is not low. Ethylene glycol provides the best compromise of these three examples by providing a fairly low viscosity, a high surface tension, and a low vapor pressure.

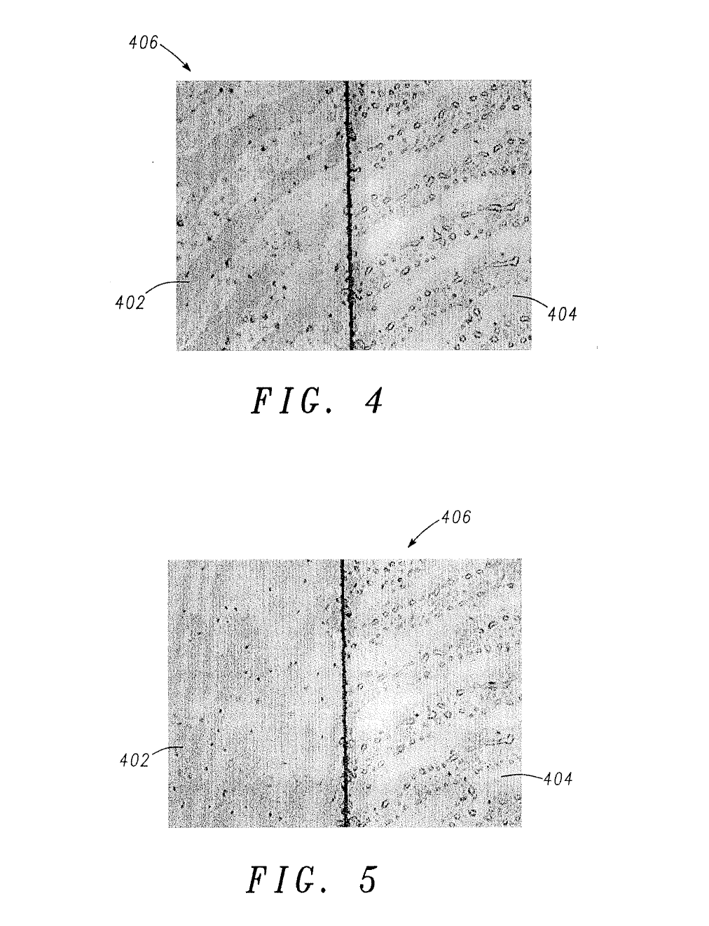

FIGS. 4 and 5 are pictures of a comparison of a porous aluminum multi-phase matrix 402 having a glycerol liquid applied positioned adjacent a glass surface 404. FIG. 4 shows a smudge (fingerprint) 406 immediately after being applied and FIG. 5 shows the smudge 406 after a time delay of about 12 hours. It is recognized that the smudge 406 is not observable on the porous aluminum multi-phase matrix 402 in FIG. 5.

It has been shown that a solid porous multi-phase structure having a liquid disposed within the porous multi-phase structure reduces or eliminates smudges from the surface thereof.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A device comprising:
a housing;
a display disposed within the housing and including a viewable surface; and
a multi-phase structure disposed upon at least one of the housing and viewable surface.

2. The device of claim 1 wherein the display comprises a touch panel disposed within the device.

3. The device of claim 1 wherein the housing comprises a polymer.

4. The device of claim 1 wherein the viewable surface comprises glass.

5. The device of claim 1 wherein the multi-phase structure comprises porous alumina.

6. The device of claim 1 wherein the multi-phase structure comprises:
a solid porous material defining a plurality of pores; and
a non-solid material disposed within the plurality of pores.

7. The device of claim 1 wherein the non-solid material comprises one of water and glycerol.

8. The device of claim 1 wherein the device further comprises portable communication circuitry disposed within the housing.

9. A device having a viewable surface comprising:
a supporting layer; and
a solid porous matrix having a first side disposed on the supporting layer and defining a plurality of pores opening to a second side opposed to the first side; and
a non-solid material disposed within the plurality of pores.

10. The device of claim 9 wherein the supporting layer comprises a housing of the device.

11. The device of claim 9 wherein the supporting layer comprises a display disposed within the device.

12. The device of claim 9 wherein the supporting layer comprises a touch panel disposed within the device.

13. The device of claim 9 wherein the supporting layer comprises one of polymer or glass.

14. The device of claim 9 wherein the solid porous matrix comprises porous alumina.

15. The device of claim 9 wherein the non-solid material comprises one of water and glycerol.

16. The device of claim 9 wherein the device further comprises portable communication circuitry disposed within the housing.

17. A device comprising:
a display including a transparent layer; and
a multi-phase structure disposed on the transparent layer, the multi-phase structure comprising:
a solid porous matrix defining a plurality of pores; and
a non-solid material disposed within the pores.

18. The device of claim 17 wherein the transparent layer comprises a polymer.

19. The device of claim 17 wherein the transparent layer comprises glass.

20. The device of claim 17 wherein the multi-phase structure comprises porous alumina.

21. The device of claim 17 wherein the non-solid material comprises one of water and glycerol.

22. The device of claim 17 wherein the device further comprises portable communication circuitry disposed within the transparent layer.
